(19) United States
(12) Patent Application Publication
(10) Pub. No.: US 2026/0147119 A1
(43) Pub. Date: May 28, 2026

(54) METHOD FOR ENVIRONMENT SCANNING BY MEANS OF LIDAR

(71) Applicant: Robert Bosch GmbH, Stuttgart (DE)

(72) Inventors: Jannik Steinkamp, Muenchen (DE); David Peter, Stuttgart (DE); Alexander Braun, Ditzingen (DE); Christian Behrens, Tuebingen (DE); Daniel Kuhner, Marbach (DE)

(21) Appl. No.: 19/385,215

(22) Filed: Nov. 11, 2025

(30) Foreign Application Priority Data
Nov. 22, 2024 (DE) 10 2024 211 224.0

(51) Int. Cl. G01S 17/89; G01S 7/48; G01S 17/42; G01S 17/931

(52) U.S. Cl. CPC G01S 17/89; G01S 7/4802; G01S 17/42; G01S 17/931

(57) ABSTRACT

A method for environment scanning using LiDAR. The method includes: emitting a primary beam into an environment; receiving secondary beams reflected by objects in the environment; determining a multiple reflection value for each secondary beam; assigning each secondary beam a coordinate point in the environment; and providing a point cloud having the coordinate points, wherein, for each coordinate point, the multiple reflection value determined for the associated secondary beam is stored, wherein the multiple reflection value contains information regarding whether the associated secondary beam belongs to a group of multiple reflections.

### CROSS REFERENCE

The present application claims the benefit under 35 U.S.C. § 119 of Germany Patent Application No. DE 10 2024 211 224.0 filed on Nov. 22, 2024, which is expressly incorporated herein by reference in its entirety.

### FIELD

The present invention relates to a method for environment scanning by means of LiDAR, and to a vehicle comprising a LiDAR system for carrying out such a method for object recognition.

### SUMMARY

For the current driving assistance systems, the quality of the data captured by the LiDAR sensors is critical for recognizing objects in the environment. Such sensors for capturing the environment include LiDAR systems. Current LiDAR systems are configured to transmit a beam by means of a transmitting unit. The emitted beam is reflected on objects in the environment and the secondary beam is sent back to a receiving unit of the LiDAR system. A propagation time in relation to the emitted primary beam is assigned to the received secondary beam. Thus, the distance of an object from the LiDAR system can be determined on the basis of the propagation time. Furthermore, the receiving unit can determine at what angles, comprising an azimuth angle and a vertical angle, and from what distance a secondary beam was received. This makes it possible to record a point in the environment in a three-dimensional coordinate system. Furthermore, current receiving units are configured to also determine the intensity of the secondary beam. This information is evaluated in a subsequent step so that the environment is represented as a point cloud on the basis of the received secondary beams. On the basis of this point cloud, an environment or objects in the environment can be captured.

### SUMMARY

A method according to the present invention for object recognition by means of LiDAR may have the advantage over the conventional methods that information from the multiple reflection of the same primary beam is better evaluated. As a result, an improved point cloud of an environment can be created. Multiple reflection may be attributed to certain objects in the environment. Multiple reflection may be attributed to an edge and/or a reflective object and/or to smaller objects in the environment such as branches, leaves and the like. Multiple reflection may also be attributed to corresponding moisture in the atmosphere or in the beam of the primary secondary beam. By evaluating the information from multiple reflections, the quality of representation of the environment of the LiDAR system can be improved.

This may be achieved according to an example embodiment of the present invention in that the method for environment scanning by means of LiDAR comprises the following steps. A first step comprises emitting a primary beam into an environment. A second step comprises receiving secondary beams reflected on objects in the environment. A representation of the environment, for example a point cloud, can be created from the information of the secondary beams. A third step comprises determining a multiple reflection value for each received secondary beam. A fourth step comprises assigning each received secondary beam a coordinate point in the environment.

A fifth step comprises providing a point cloud. The point cloud has the coordinate points ascertained in the fourth step; for each coordinate point, the multiple reflection value determined for the associated secondary beam in the third step is stored. In this way, the information regarding whether a coordinate point of the point cloud is a multiple reflection is stored for the coordinate point and may be taken into account when using the point cloud for downstream applications. The information regarding multiple reflections of the originally emitted primary beam is thus optimally taken into account.

The multiple reflection value here comprises information regarding whether the associated secondary beam belongs to a group of multiple reflections.

In other words, a primary beam is emitted by the LiDAR into the environment and reflected on objects. If these are objects that backscatter a multiple reflection, i.e., reflect multiple reflection secondary beams for a primary beam to be emitted, these secondary beams are encoded by means of a multiple reflection value. This allows the multiple reflection of the secondary beams to be taken into account in the creation of a point cloud. This in turn results in greater information content in the point cloud, which allows, for example, reliable object recognition as well as reliable automated driving of a vehicle having such a LiDAR system and/or improved robotics and/or remote sensing and/or geoinformation systems.

Preferred developments of the present invention are disclosed herein.

Preferably, all captured secondary beams which belong to the same primary beam are taken into account for determining the multiple reflection value. An advantage of this example embodiment may be that a clearly specific multiple reflection value can thus be ascertained.

Preferably, according to an example embodiment of the present invention, the determining of the multiple reflection value comprises the following steps. A sixth step comprises ascertaining an intensity of the secondary beams or a distance of the environment objects on which the secondary beams were reflected. A seventh step comprises sorting the received secondary beams according to the ascertained intensity or the associated distance and assigning each secondary beam an ordinal number. An eighth step comprises determining the sum of all received secondary beams. A ninth step comprises ascertaining the multiple reflection value for each secondary beam according to the ordinal number of the particular secondary beam and the sum of all secondary beams. An advantage of this example embodiment may be that it is possible to encode a specific property of the individual secondary beam in the associated multiple reflection value. It is thus possible to encode in the multiple reflection value whether the specific secondary beam is the first, second or e.g. third received secondary beam from the group of the multiple reflections. This allows a more precise determination of the environment objects in the subsequent fifth step.

Preferably, according to an example embodiment of the present invention, the multiple reflection value is formed from a quotient of the ordinal number of the secondary beam and of the sum of all secondary beams which are assigned to the same primary beam. An advantage of this embodiment may be that, with low computational effort, each secondary beam can be assigned an unambiguous multiple reflection value which also comprises information regarding the particular individual secondary beam.

Preferably, according to an example embodiment of the present invention, the determining of the multiple reflection value comprises the following steps. A tenth step comprises ascertaining the intensity of each secondary beam which is assigned to the same primary beam. An eleventh step comprises determining the sum of the intensities of all secondary beams which are assigned to the same primary beam. A twelfth step comprises determining the multiple reflection value of each secondary beam on the basis of the intensity of each secondary beam and the sum of the intensities of all secondary beams which are assigned to the same primary beam. An advantage of this embodiment may be that, on the basis of the intensity of the particular secondary beam that is encoded in the multiple reflection value, information regarding the reflectivity of an object in the environment on which the secondary beam was reflected is conveyed. The reflectivity describes the ratio of the intensity of the reflected secondary beam to the intensity of the primary beam incident on the environment object.

Preferably, according to an example embodiment of the present invention, the multiple reflection value is formed from a quotient of the intensity of the secondary beam and of the sum of the intensity of all secondary beams which are assigned to the same primary beam. An advantage of this embodiment may be that it is possible, on the basis of the proportion of the intensity of the one secondary beam in relation to the sum of all intensities of all secondary beams, to make the recognition of objects in the environment more precise.

Preferably, according to an example embodiment of the present invention, the method for object recognition comprises the following steps. A thirteenth step comprises determining the horizontal angles and the vertical angles of the received secondary beams. A fourteenth step comprises assigning multiple secondary beams to the same primary beam on the basis of the horizontal angles and the vertical angles of the secondary beams. An advantage of this embodiment may be that the assigning of multiple secondary beams to a primary beam on the basis of the horizontal angles and the vertical angles allows precise assignment.

Advantageously, according to an example embodiment of the present invention, it is provided that the point cloud is processed by means of artificial intelligence, taking into account the stored multiple reflection values. The artificial intelligence is in particular a neural network. The processing by the artificial intelligence comprises, for example, classifying the entire point cloud and/or classifying each point in the point cloud according to predefined classes, also referred to as semantic segmentation, and/or classifying each point in the point cloud according to predefined classes as well as instances, also referred to as panoptic segmentation, and/or recognizing, and in particular classifying, objects within the point cloud. By using the multiple reflection value when performing the processing, improved consideration of multiple reflections of the originally emitted primary beam is made possible. This improves the results of the processing of the point cloud.

The present invention further relates to a LiDAR system comprising a transmitting unit, a receiving unit and a control unit. The transmitting unit is configured to emit a primary beam into an environment. The receiving unit is configured to receive a reflected secondary beam. The control unit is connected to the transmitting unit and the receiving unit for signal exchange. The control unit is configured to carry out a method for environment scanning according to one of the above-described embodiments of the present invention.

The present invention further relates to a vehicle comprising a LiDAR system according to the above-described embodiments of the present invention.

The present invention further relates to a computer program configured to carry out a method according to one of the above-described embodiments of the present invention.

The present invention further relates to a machine-readable storage medium on which a computer program according to the above-described embodiment of the present invention is stored.

Preferably, in the ascertaining of the multiple reflection value, for each constellation of the ordinal number of the secondary beam and of the sum of the secondary beams which are assigned to the same primary beam a further ordinal number is assigned. An advantage of this embodiment may be that, merely from the particular multiple reflection value of the secondary beam, it can be discerned what the sum of all secondary beams which are assigned to the same primary beam is.

### BRIEF DESCRIPTION OF THE DRAWINGS

Embodiment examples of the present invention are described in detail in the following with reference to the figures.

FIG. 1 shows a schematic illustration of a vehicle having a LiDAR system according to an embodiment example of the present invention.

FIG. 2 shows a schematic illustration of a LiDAR system according to an embodiment example of the present invention.

FIG. 3 shows a schematic illustration of a method for environment scanning according to an embodiment example of the present invention.

FIG. 4 shows a schematic illustration of a method for environment scanning according to the embodiment example of the present invention, according to a first variant.

FIG. 5 shows a schematic illustration of a method for environment scanning according to the embodiment example of the present invention, according to a second variant.

FIG. 6 shows a schematic illustration of a method for environment scanning according to the embodiment example of the present invention, according to a third variant.

FIG. 7 shows a schematic illustration of a method for environment scanning according to the embodiment example of the present invention, according to a fourth variant.

### DETAILED DESCRIPTION OF EXAMPLE EMBODIMENTS

All elements, units and/or assemblies in all figures preferably have the same reference signs.

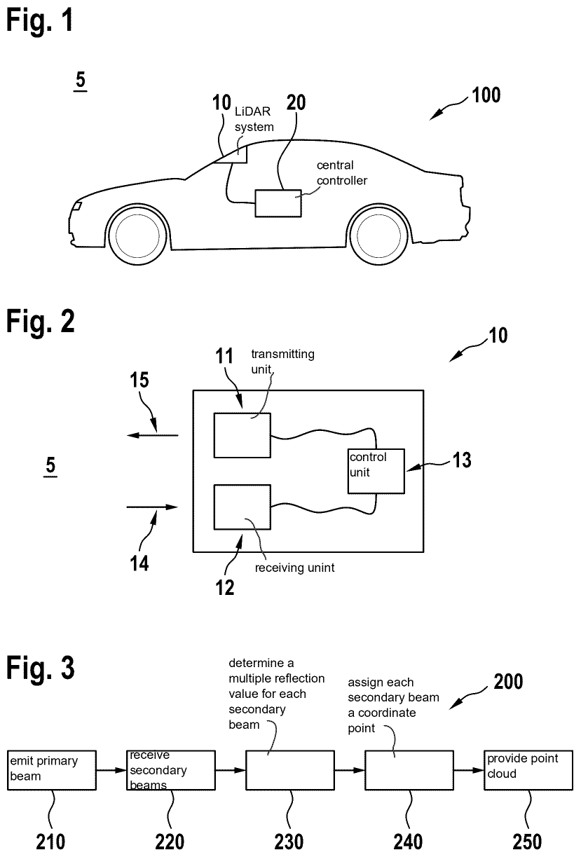

FIG. 1 shows a schematic illustration of a vehicle 100 having a LiDAR system 10 according to an embodiment example of the present invention. The vehicle comprises a central controller 20, which is connected to the LiDAR system 10 for signal exchange. The central controller 20 is configured to evaluate the information received from the LiDAR system 10 and to recognize objects in environment 5 of the vehicle 100. The central controller 20 is configured to execute a driver assistance system and to take the information from the LiDAR system 10 into account when executing the driver assistance system. The central controller 20 is configured to influence the lateral guidance and the longitudinal guidance of the vehicle 100 on the basis of an output of the driver assistance system.

FIG. 2 shows a schematic illustration of a LiDAR system 10 according to an embodiment example of the present invention. The LiDAR system 10 comprises a transmitting unit 11, a receiving unit 12 and a control unit 13. The transmitting unit 11 is configured to emit a primary beam 15 into the environment 5. The receiving unit 12 is configured to receive a reflected secondary beam 14. The control unit 13 is connected to the transmitting unit 11 and the receiving unit 12 for signal exchange. The control unit 13 is configured to carry out a method 200 for environment scanning according to an embodiment example according to the present invention, as described below.

Sometimes, primary beams emitted into the environment lead to multiple reflection on various objects in the environment. Thus, a receiving unit 12 receives multiple secondary beams 14 which it can associate with a primary beam 15. The information regarding the fact that a multiple reflection is concerned and regarding the exact properties of the individual secondary beam can provide information about the nature of the object that resulted in the multiple reflection of the primary beam. This information can be used in the subsequent steps, for the evaluation and for object recognition, and allows for more precise recognition of objects in the environment.

FIG. 3 shows a schematic illustration of the method 200 for environment scanning according to the embodiment example. The method 200 for environment scanning comprises the following steps. A first step 210 comprises emitting a primary beam 15 into an environment 5. A second step 220 comprises receiving secondary beams 14 reflected on the objects in environment 5. A third step 230 comprises determining a multiple reflection value for each secondary beam 14. A fourth step 240 comprises assigning each secondary beam 14 a coordinate point in the environment 5. A fifth step 250 comprises providing a point cloud having the coordinate points, wherein, for each coordinate point, the multiple reflection value determined for the associated secondary beam 14 is stored.

The multiple reflection value comprises information regarding whether the associated secondary beam belongs to a group of multiple reflection on an object in the environment. The determining of the multiple reflection value is based on all captured secondary beams 14 which are assigned to the same primary beam 15.

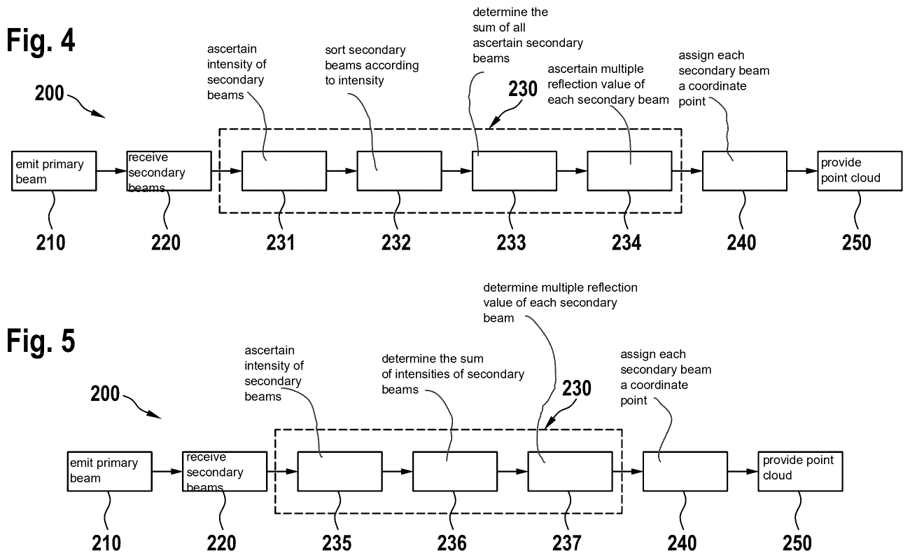

FIG. 4 shows a schematic illustration of a first variant of the method 200 for environment scanning. In this variant, the determination of the multiple reflection value in the third step 230 comprises the following steps: A sixth step 231 comprises ascertaining an intensity of the secondary beams 14 and a distance of the environment objects on which the secondary beams 14 were reflected. A seventh step 232 comprises sorting the secondary beams 14 according to the ascertained intensity or the associated distance and assigning each secondary beam 14 an ordinal number. An eighth step 233 comprises determining the sum of all ascertained secondary beams 14 belonging to the same primary beam 15. A ninth step comprises ascertaining 234 the multiple reflection value of each secondary beam 14 according to the ordinal number of the particular secondary beam and the sum of all secondary beams 14.

In the order of the steps, the second step 220, receiving secondary beams 14 reflected by objects in environment, is followed by the sixth step 231, ascertaining an intensity of the secondary beams. The ninth step 234, ascertaining a multiple reflection value for each reflection beam, is followed by the fourth step 240, assigning each secondary beam a coordinate point in the environment 5. The determination of the multiple reflection value is formed from a quotient of the ordinal number of the particular secondary beam 14 and of the sum of all secondary beams 14 which are assigned to the same primary beam 15.

FIG. 5 shows a second variant of the method 200 for environment scanning. In this variant, the following steps are carried out to determine the multiple reflection value, i.e. as part of the third step 230: A tenth step 235 comprises ascertaining the intensity of each secondary beam 14 which is assigned to the same primary beam 15. An eleventh step 236 comprises determining the sum of the intensities of all secondary beams 14 which are assigned to the same primary beam 15. A twelfth step 237 comprises determining the multiple reflection value of each secondary beam 14 on the basis of the intensity of each secondary beam 14 and the sum of the intensities of all secondary beams 14 which are assigned to the same primary beam 15. The multiple reflection value is formed from a quotient of the intensity of the particular secondary beam 14 and of the sum of the intensities of all secondary beams 14 which are assigned to the same primary beam 15.

In the order of the steps, the tenth step 235 follows the second step 220, and the fourth step 240 is performed after the twelfth step 237.

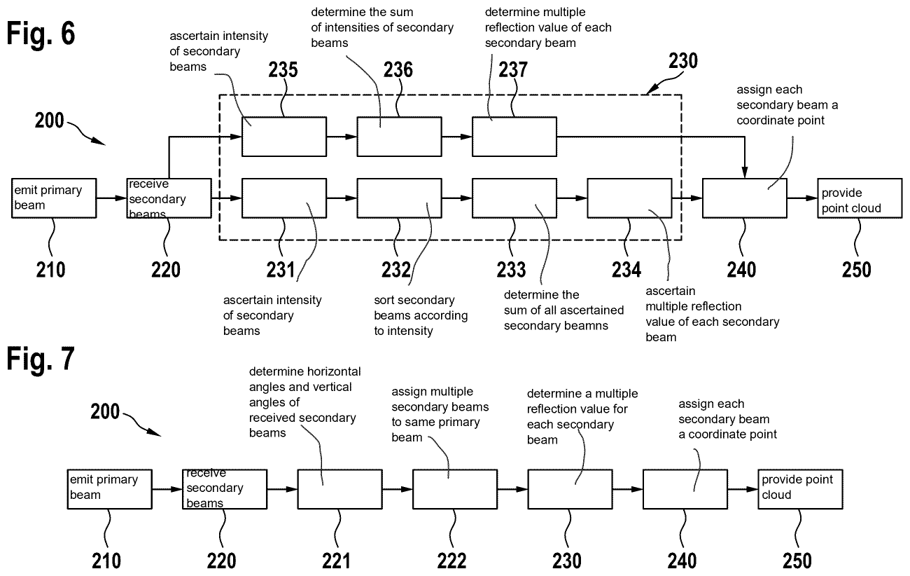

FIG. 6 shows a schematic illustration of a third variant of the method 200 for environment scanning. This variant is in particular a combination of the first variant and the second variant. In the third variant, the second step 220, receiving secondary beams 14 reflected by objects in the environment 5, is followed by both the calculation according to the first variant and the calculation according to the second variant.

Thus, the tenth step 235 to the twelfth step 237 and the sixth step 231 to the ninth step 234 are performed in parallel with one another as the third step 230 after the second step 220. The calculations of the multiple reflection value which involve the steps performed in parallel are then taken into account in the providing of the point cloud in the fifth step 250.

FIG. 7 shows a schematic illustration of a fourth variant of the method 200 for environment scanning. In this variant, the method 200 comprises a thirteenth step 221 and a fourteenth step 222 which are performed after the second step 220 and before the third step 230.

The thirteenth step 221 comprises determining the horizontal angles and the vertical angles of the received secondary beams 14. The fourteenth step 222 comprises assigning multiple secondary beams 14 to the same primary beam 15 on the basis of the horizontal angles and the vertical angles of the secondary beams 14. Preferably, this variant can also be combined with the above-described variants, all of which concern the third step 230.

The point cloud created as described above is preferably processed using artificial intelligence. The artificial intelligence is in particular a neural network. In the processing, the multiple reflection value stored for each coordinate point is taken into account, whereby information from the multiple reflection is optimally used to improve the processing. The processing comprises, In particular, classifying the entire point cloud and/or classifying each point in the point cloud according to predefined classes, also referred to as semantic segmentation, and/or classifying each point in the point cloud according to predefined classes as well as instances, also referred to as panoptic segmentation, and/or recognizing, and in particular classifying, objects within the point cloud.

What is claimed is:

1. A method for environment scanning using LiDAR, comprising the following steps:
emitting a primary beam into an environment;
receiving secondary beams reflected by objects in the environment;
determining a multiple reflection value for each respective second beam of the secondary beams;
assigning each of the secondary beams a coordinate point in the environment; and
providing a point cloud having the coordinate points, wherein, for each of the coordinate points, the multiple reflection value determined for the respective beam is stored;
wherein each of the multiple reflection values contains information regarding whether the respective secondary beam belongs to a group of multiple reflections.

2. The method according to claim 1, wherein the determining of the multiple reflection value is based on all of the received secondary beams which belong to a same primary beam.

3. The method according to claim 1, wherein the determining of the multiple reflection value includes the following steps:
ascertaining an intensity of the secondary beams or an associated distance of environment objects on which the secondary beams were reflected;
sorting the secondary beams according to the ascertained intensity or the associated distance, and assigning each of the secondary beams an ordinal number;
determining a sum of all of the secondary beams; and
ascertaining the multiple reflection value for each of the secondary beams according to the ordinal number of the secondary beam and the sum of all of the secondary beams.

4. The method according to claim 1, wherein the multiple reflection value is formed from a quotient of the ordinal number of the respective secondary beam and of the sum of the secondary beams which are assigned to the same primary beam.

5. The method according to claim 1, wherein the determining of the multiple reflection value includes the following steps:
ascertaining the intensity of each of the secondary beams which is assigned to the same primary beam;
determining a sum of the intensities of all of the secondary beams which are assigned to the same primary beam; and
determining the multiple reflection value of the respective secondary beam, based on the intensity of the respective secondary beam and the sum of the intensities of all of the secondary beams which are assigned to the same primary beam.

6. The method according to claim 1, wherein the multiple reflection value is formed from a quotient of the intensity of the secondary beams and of the sum of the intensity of all of the secondary beams which are assigned to the same primary beam.

7. The method according to claim 1, further comprising the following steps:
determining horizontal angles and vertical angles of the received secondary beams; and
assigning multiple of the secondary beams to a same primary beam based on the horizontal angles and the vertical angles of the secondary beams.

8. The method according to claim 1, characterized in that the point cloud is processed using artificial intelligence including a neural network, taking into account the stored multiple reflection values, including:
classifing the entire point cloud and/or
classifying each of the points in the point cloud according to predefined classes including semantic segmentation, and/or
classifining each of the points in the point cloud according to predefined classes and instances including panoptic segmentation, and/or
recognizing including classifing objects within the point cloud.

9. A LiDAR system, comprising
a transmitter configured to emit a primary beam into an environment;
a receiver configured to receive reflected secondary beams; and
a control unit, wherein the control unit is connected to the transmitter and the receiver for signal exchange,
wherein the control unit is configured to carry out a method for environment scanning using LiDAR, the method including the following steps:
emitting the primary beam into the environment;
receiving the secondary beams reflected by objects in the environment,
determining a multiple reflection value for each respective second beam of the secondary beams,
assigning each of the secondary beams a coordinate point in the environment, and
providing a point cloud having the coordinate points, wherein, for each of the coordinate points, the multiple reflection value determined for the respective beam is stored,
wherein each of the multiple reflection values contains information regarding whether the respective secondary beam belongs to a group of multiple reflections.

10. A vehicle, comprising:
a LiDAR system, including:
a transmitter configured to emit a primary beam into an environment,
a receiver configured to receive reflected secondary beams, and
a control unit, wherein the control unit is connected to the transmitter and the receiver for signal exchange,
wherein the control unit is configured to carry out a method for environment scanning using LiDAR, the method including the following steps:
emitting the primary beam into the environment;
receiving the secondary beams reflected by objects in the environment,
determining a multiple reflection value for each respective second beam of the secondary beams,
assigning each of the secondary beams a coordinate point in the environment, and
providing a point cloud having the coordinate points, wherein, for each of the coordinate points, the multiple reflection value determined for the respective beam is stored,
wherein each of the multiple reflection values contains information regarding whether the respective secondary beam belongs to a group of multiple reflections.

11. A non-transitory machine-readable storage medium on which is stored a computer program for environment scanning using LiDAR, the computer program, when executed by a computer, causing the computer to perform the following steps comprising:
emitting a primary beam into an environment;
receiving secondary beams reflected by objects in the environment;
determining a multiple reflection value for each respective second beam of the secondary beams;
assigning each of the secondary beams a coordinate point in the environment; and
providing a point cloud having the coordinate points, wherein, for each of the coordinate points, the multiple reflection value determined for the respective beam is stored;
wherein each of the multiple reflection values contains information regarding whether the respective secondary beam belongs to a group of multiple reflections.
